(19) United States
(12) Patent Application Publication
(10) Pub. No.: US 2012/0272126 A1
(43) Pub. Date: Oct. 25, 2012

(54) System And Method For Producing A Media Compilation

(76) Inventors: Clayton Brian Atkins, Mountain View, CA (US); Nina Bhatti, Los Altos, CA (US); Daniel R. Tretter, San Jose, CA (US)

(21) Appl. No.: 13/260,324

(22) PCT Filed: Jul. 29, 2009
(86) PCT No.: PCT/US09/52164

§ 371 Date: Sep. 25, 2011

(51) Int. Cl. G06F 17/00

(52) U.S. Cl. 715/202

(57) ABSTRACT

A system and method for producing a media compilation is described.

### BACKGROUND

The advent of digital photography has revolutionized the way people organize and display their photographs. Photos can be stored on a hard disk, flash drive or other storage media while photos can be displayed in a digital photo frame, DVD, or printed directly into a book format. In this way, one can simply bypass the labor intensive, conventional process of printing all the photos, sorting them, and then securing them in a desired arrangement into a book.

However, digital photography also tends to produce a much higher volume of photographs than with film camera. As a result, an enormous amount of time can be spent sorting through a large multitude of photographs to select photos to be displayed. After such sorting, one spends even more time organizing the selected photos into a desired arrangement of a photo book or other types of display.

While there have been some attempts to automate the sorting and selection process, a considerable amount of human interaction is used to adjust or finalize the final arrangement of displayed photos. Moreover, the conventional automated systems lack an effective way to harness this human interaction to make future productions easier.

For at least these reasons, consumers still face considerable challenges in efficiently producing displays of photos.

### BRIEF DESCRIPTION OF THE DRAWINGS

FIG. 1 is a flow diagram of a method of building a media compilation, according to an embodiment of the present invention.

FIG. 2 is a block diagram of a compilation manager, according to an embodiment of the present invention.

FIG. 3 is a block diagram of a content metadata monitor, according to an embodiment of the present invention.

FIG. 4 is a block diagram of an editing metadata monitor, according to an embodiment of the present invention.

FIG. 5 is diagram schematically illustrating a method of producing a media compilation, according to an embodiment of the present invention.

FIG. 6 is a diagram schematically illustrating a method of producing a media compilation, according to an embodiment of the present invention.

FIG. 7 is a block diagram of a system for producing a media compilation, according to an embodiment of the present invention.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments of the present invention enable an author to generate a second media compilation as a derivative of a first media compilation by leveraging the editing metadata generated during creation of the first media compilation. After identifying a subset of the content of the first media compilation (or even some alternate content), the editing metadata from the first media compilation is automatically applied to the identified content (e.g. subset and/or alternate content) to automatically generate the second media compilation. In this way, an author can readily create the second media compilation from the subset of the content of the first media compilation by taking advantage of the previous composition and editing work expressed in the first media compilation. In other words, an author need not start over in their composition and editing work when assembling a second media compilation that is related to the first media compilation. Of course, it will be understood that this process may be performed recursively, such that additional, successive media compilations are derived iteratively from preceding media compilations.

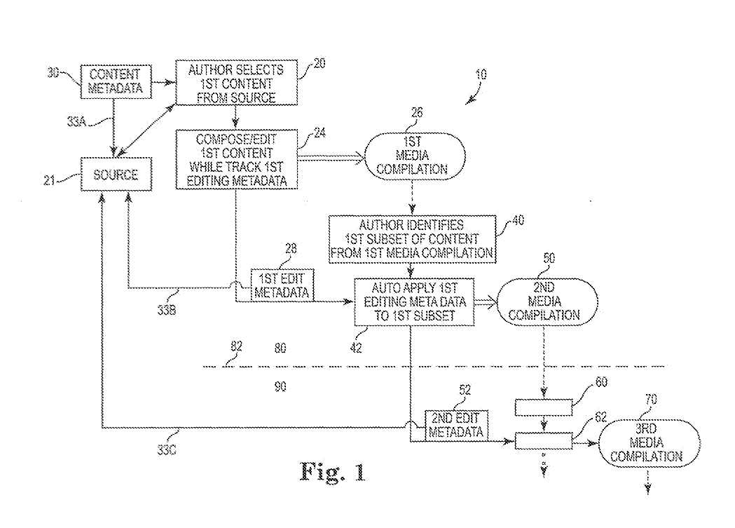

These embodiments, and additional embodiments, as more fully described and illustrated in association with FIGS. 1-7.

FIG. 1 is a flow diagram of a method 10 of building a media compilation, according to one embodiment of the present disclosure. In general terms, method 10 enables an author to create a second media compilation 50 using information from a first media compilation 26. In one aspect, first editing metadata 28 is created as a byproduct of creation of the first media compilation 26 and this editing metadata 28 is automatically applied, along with other user input, to generate the second media compilation 50 as a derivative of the first media compilation 26.

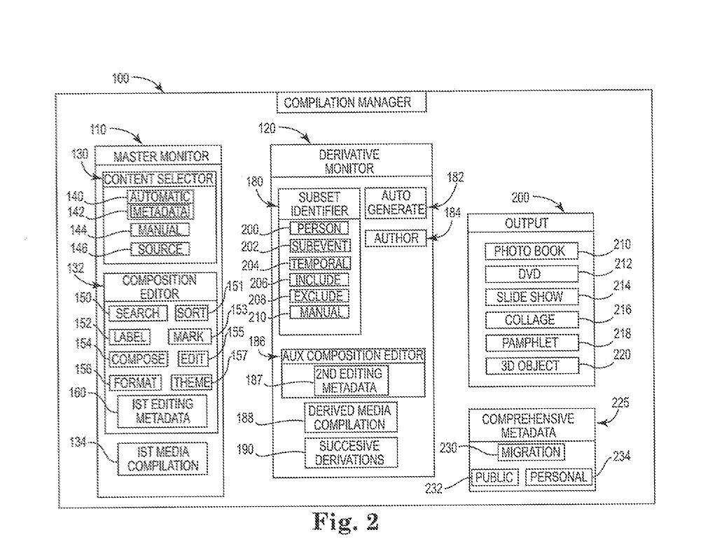

It will be understood that, in some embodiments, method 10 is performed using one or more of the parameters, function's, modules, monitors, managers, systems, etc. that will be described in association with FIGS. 2-7, while in other embodiments, method 10 will be performed using other systems.

As shown in FIG. 1 at 20, in method 10 an author selects a first content of media elements from a source, such as source 21. In one embodiment, a media element comprises at least one of an image (including, but not limited to, photos), graphics, or text. While many examples herein refer to photos, it will be understood that another type of media element, such as a graphic or other type of image could be used instead of, or along with, the photo.

In one example, the author can electronically access a source such as database of photos and access a collection of photos via selecting a category such as sports, vacation, or other themes or categories. The author defines the first content by selecting just some of the photos in one or more of these categories until the desired collection of photos are present in electronic form.

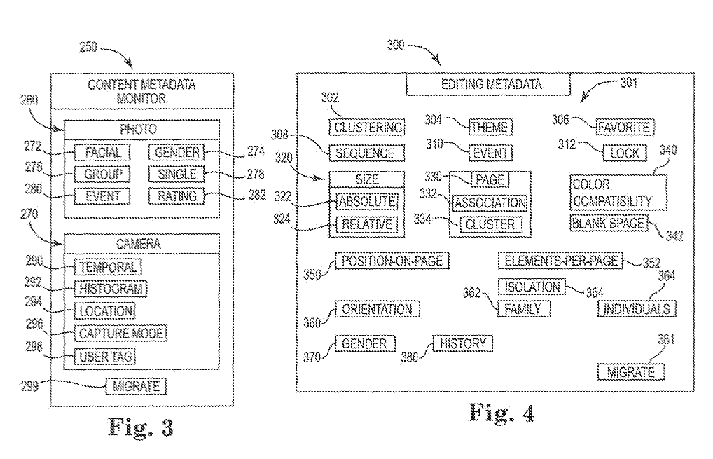

In one embodiment, the first content is at least partially defined through the use of content metadata 30 associated with the photos or other media elements. For example, information associated with each photo (at the time the photo is taken) can be used to help sort and select photos. Accordingly, each photo includes a metadata tag storing this information, which may include a time or date the photo was taken, a location (e.g. GPS) the photo was taken, etc. In addition, the object within the photo also can yield content metadata 30 regarding whether there are any persons in the photo and how many, or what color is predominant in the photo. Further examples of such content metadata 30 are further described later in association with at least FIG. 3.

Accordingly, an author can select photos to define the first content of the first media compilation 26 according to one or more aspects of content metadata 30. For example, an author can sort and select photos that have just one person in the photo or select photos limited to groups of people. It will be understood that more sophisticated ways of using content metadata 30, familiar to those skilled in the art, can be used to sort and select photos to define the first content.

Next at 24, method 10 includes the author uses a tool (e.g., a photo editing program) to compose and edit the first content into a desired arrangement as the first media compilation 26 while, at the same time, method 10 tracks the first editing metadata 28 produced as byproduct of the composing and editing by the author. As a result, the effort and time spent by the author in composing and editing is captured via the first editing metadata 28 and can be leveraged for future uses. Upon the completion of the composing and editing, the first media compilation 26 is produced that displays the media elements (e.g. graphics, images, text, etc.) in the desired arrangement.

In one aspect, it will be understood that the composing and editing includes selecting a format, such as a photobook, slideshow, collage and arranging the photos within that selected format. This process includes several aspects, such as, but not limited to, choosing: (1) how many photos will appear on a single page: (2) the relative sizes of the photos; (3) their orientation; (4) a sequence of the photos; and/or (5) how the photos are grouped together. In one aspect, the author can choose a predetermined format according to one or more themes, such as a birthday, sports season, wedding, etc. This predetermined format reduces the number of decisions made by the author. However, even within this predetermined format, a considerable number of decisions are made regarding the photos. In some embodiments, an automated process can be applied to automatically populate the fields in the predetermined format with photos that are automatically selected according to their content metadata. However, even in this scenario, the author will make many decisions in modifying and editing the arranged photos in the predetermined format to achieve the final arrangement that comprises the first media compilation 26.

These actions result in a first media compilation 26 and, as noted above, result in the first editing metadata 28 that captures all the decisions made by the author in composing and editing the first media compilation 26.

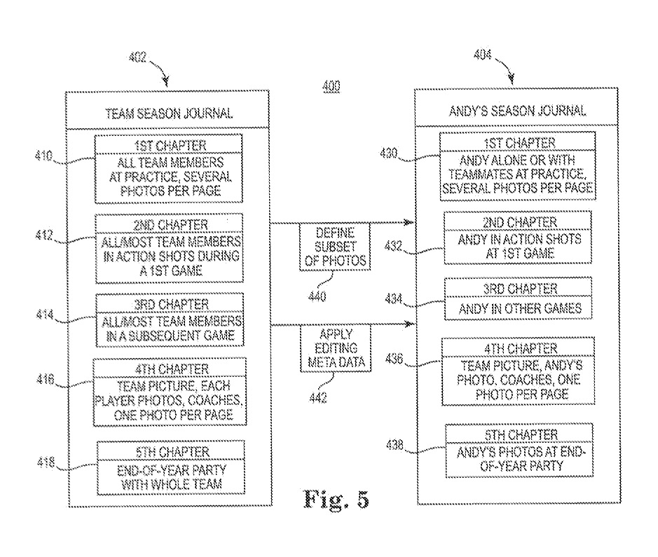

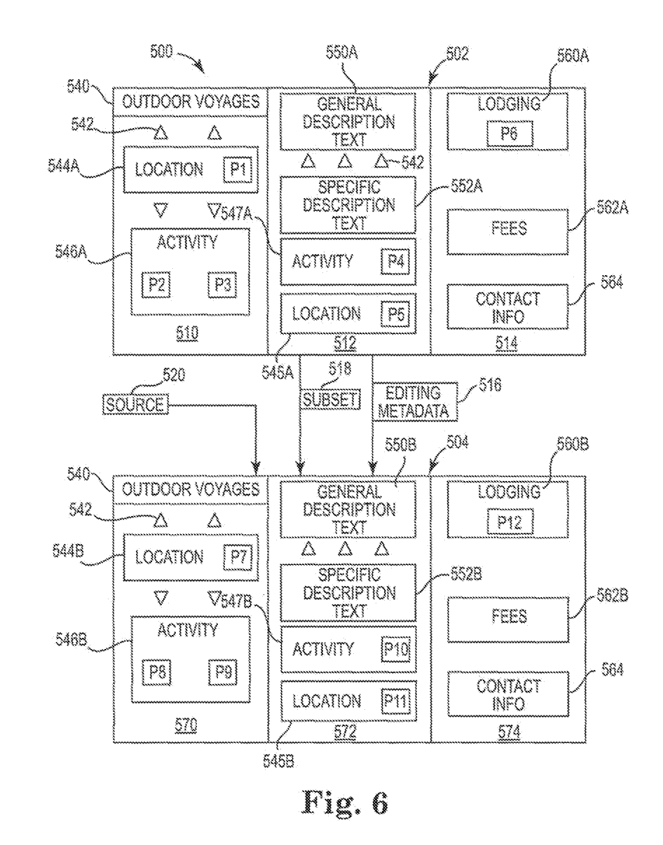

In another aspect, method 10 includes producing a second media compilation 50 from both the first media compilation 26 and the first editing metadata 28. To do so, at 40 in method 10, the author identifies a first subset of content from the first media compilation 26, and then at 42, the method 10 automatically applies the first editing metadata 28 to the first subset of content to automatically generate the second media compilation 50. In one simple, non-limiting example, defining the first subset can result in intentionally excluding photos of a certain individual (e.g., Aunt Mabel) from the first media compilation and/or can result in intentionally including photos that all include a certain individual (e.g. Uncle Harry). Of course, the first subset can be defined in many other ways as a modification of the first content. However, in general terms, the first subset will be a truncation of the first content to achieve a much smaller collection of photos from which the second media compilation will be formed. At least a couple of non-limiting examples of these various aspects of performing method 10 are further described later in association with at least FIGS. 5-6.

It will be further understood that, in some embodiments, the author can access the source from which the first content (of the first media compilation) was defined to include one or more photos beyond the first content.

In one embodiment, after the second media compilation is produced, the method 10 terminates.

However, in some embodiments, additional or successive media compilations are derived from the second media compilation. Accordingly, in one aspect, as shown in FIG. 1 at 52, 60, 62, and 70, the method 10 is recursive such that successive media compilations, such as a third media compilation 70, are derived from a preceding media compilation (e.g., second media compilation 50) with each successive media compilation being automatically generated, in part, from the editing metadata (e.g. second editing metadata 52) produced from the preceding media compilations (e.g. second media compilation 50).

In one non-limiting example of the recursive application of method 10, a first media compilation covers an entire wedding party, a second media compilation covers the groom's side, a third media compilation covers the groom's brothers, and the fourth media compilation is limited to the groom.

In one aspect, the production of the second media compilation 50 is illustrated in the first region 80 above the dashed line 82 of FIG. 1 while production of one or more successive media compilations 70 is illustrated in the second region 90 below dashed line 82 of FIG. 1.

In some embodiments, method 10 includes one or more feedback pathways 33A, 33B, 33C by which metadata migrates back to source 21 to update metadata associated with each of the corresponding media elements and/or media compilations accessible at source 21. In this way, method 10 takes metadata created from the work of authors (during production of prior media compilations) and makes this metadata available to assist an author in producing other media compilations. Accordingly, in method 10 as shown in FIG. 1, a copy of content metadata 30 migrates to source 21 via pathway 33A, a copy of first metadata 28 migrates to source 21 via pathway 338, and a copy of second metadata 52 migrates to source 21 via pathway 33C. With this in mind, a more detailed description of the management of metadata and its migration back to a source of media elements (and/or media compilations) is provided later in association with at least FIGS. 2-4.

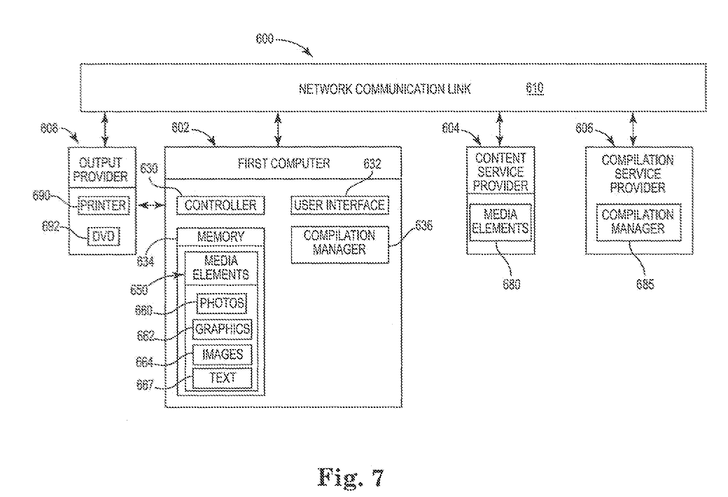

FIG. 2 is a block diagram of a compilation manager 100, according to one embodiment of the present disclosure. In general terms, compilation manager 100 operates within a computing environment to enable electronic implementation of the functions of compilation manager 100 and/or to perform method 10. In one embodiment, compilation manager 100 comprises part of a larger computer system, such as computer system 600, which is further described later in association with FIG. 7. As shown in FIG. 2, compilation manager 100 includes a master compilation monitor 110, a derivative monitor 120, an output monitor 200, and comprehensive metadata manager 225. In one embodiment, the master compilation monitor 110 includes a content selector 130, a composition editor 132, and a first media compilation 134.

In general terms, the content selector 130 enables an author to select content, such as various media elements, for inclusion into a first media compilation 134. As previously noted, the media elements include just one type of media, such as photos, or can includes several types of media, such as photos, graphics, text, and/or non-photo images.

As shown in FIG. 2, in one embodiment content selector 130 includes an automatic function 140, a manual function 144, and a source function 146. In one aspect, the manual function 144 enables an author to select each photo of the content of media compilation in a photo-by-photo manner (e.g. manually). In another aspect, the source function 146 enables an author to select which source or database from which the photos or other media elements will be selected. In some instances, the source is internal to the author (a personal media storing photos) while in other instances, the source is external, such as a third party that sells or shares media elements, including photos, graphics, text, and/or non-photo images.

The automatic function 140 enables an author to automatically generate a first content or collection of media elements (e.g. photos) from a source of media elements. In one example, the author identifies criteria such as a birthday theme and a date, such as May 2009, and then the automatic function 140 finds all photos relating to a birthday and with the requested date. In one embodiment, the automatic function 140 uses content metadata 142 associated with each of the photos to sort and identify the requested photos. In some instances, the content metadata 142 is generated by the device used to capture the image or photo while in other instances, the content metadata 142 is generated by user actions to categorize the photo or image within the source 146. Some non-limiting examples of such content metadata 142 are further described later in association with FIG. 3.

With the first content of a first media compilation being selected or defined via content selector 130, a user employs composition editor 132 to compose and/or edit the selected photos into a desired arrangement. With this in mind, composition editor 132 includes a search function 150, a sort function 151, a label function 152, a mark function 153, a compose function 154, an edit function 155, a format function 156, a theme function 157, and a first editing metadata module 160. It will be understood that the various respective functions 150-157 operate in a cooperative manner to complement each other.

In some embodiments, the search function 150 enables an author to search among photos or other media elements within a general source 146 (part of content selector 130) or within an already selected group of photos or other media elements. The search is performed via keywords or other searching protocols known in the art. The sort function 151 enables the author to sort through a selected group of photos, allowing the author to select or check photos that are to be included or excluded from a defined set. The label function 152 enables an author to add labeling information to each photo (or group of photos). In one aspect, this labeling information is descriptive and provides information about the people, places, or things in the photos or other images, such as their names, professions, residences, etc. In some embodiments, the descriptive information includes a geographic location (e.g. Niagara Falls), an event (e.g. Joe's birthday), or a theme (e.g. sports or baseball), etc. In some aspects, the labeling information is expressive, such as indicating the type of facial expression (e.g. smiling, frowning, etc.) or verbal labeling (e.g., speech occurring at the time the photo was taken) associated with the person. Some or all of the labeling information may be hidden from view when the photo will be displayed in the media compilation or, alternatively, some or all of the labeling information appears as a caption to the photo in the media compilation.

The mark function 153 is configured to designate a photo for a particular purpose or a particular placement in a media compilation (e.g. bloopers, introduction, cover, etc.).

The compose function 154 enables an author to place selected photos in a desired arrangement according to a myriad of choices. For example, some photos are grouped together on a single page of a photobook or arranged in a sequence with just one photo per page. The photos can have the same size or have different sizes relative to another. In other example, photos can be grouped together or, separated based on who is on the selected photos or based on the time or day that the photos were taken. At least some of the potential choices available via the compose function 154 generally correspond to, and are represented by, the parameters of array 301 of editing metadata monitor 300 in FIG. 4.

In cooperation with the compose function 154, the edit function 155 enables adjusting the initial arrangement created by the author via the compose function 154. These adjustments are applied to choices made by the user and/or by choices implemented when the initial arrangement is automatically generated based on content metadata.

The format parameter 156 of composition editor 132 enables the author to choose a predetermined format, such as a photo book, DVD, or collage, into which selected photos are manually or automatically populated. For example, if one predetermined format is a photo album, the selected photos are automatically placed (or manually placed) onto pages of the photo album.

The theme parameter 157 of composition editor 132 enables the author to indicate a theme associated with the selected photos. In some embodiments, an indicated theme corresponds directly to a predetermined format, while in other instances, an indicated theme does not have a directly corresponding predetermined format. For example, if one predetermined theme is a wedding theme, then photos of the bride and groom on an altar are automatically or manually placed into a field or set of pages in a photo book having a wedding format that are dedicated to such photos. Other themes include birthdays, anniversaries, etc.

The first editing metadata function 160 provides for the tracking and storage of editing metadata produced as the author applies the respective search, sort, label, mark, compose, edit, format, and/or theme functions 150-157 respectively. As further described later, this stored first editing metadata 160 greatly simplifies making successive related versions of a first media compilation 134.

As shown in FIG. 2, the compilation manager 100 also includes a derivative monitor 120. In general terms, the derivative monitor 120 is configured to adapt or modify a first media compilation 134 into a second media compilation 188 by enabling an author to select a subset of the photos in the first media compilation 134 and then automatically generate the second media compilation 188 by applying the first editing metadata 160 to the selected subset of photos. In this way, the second media compilation 188 will express the character or look and feel of the first media compilation 134 while containing a smaller collection of photos focused on one category of photos that appeared in the first media compilation 134. Accordingly, by leveraging the first editing metadata 160, the author produces a second media compilation 188, derived from the first media compilation 134, with much less work than occurred to create the first media compilation 134.

Derivative monitor 120 includes a subset identifier module 180, an auto-generate function 182, an author function 184, an auxiliary composition editor 186 (with second editing metadata function 187), a derived media compilation 188, and a successive derivations module 190.

In one embodiment, the second editing metadata function 187 provides for the tracking and storage of editing metadata produced as the author applies the respective parameters, functions, monitors, managers, and/or modules of derivative monitor 120. As further described later, this stored first editing metadata 187 greatly simplifies making successive related versions 190 of a second media compilation 188.

In general terms, the subset identifier module 180 is configured to enable the author to select a subset or portion of the photos (or of other media elements) in the first media compilation 134. In some embodiments, the subset identifier 180 includes a person parameter 200, a sub-event parameter 202, a temporal parameter 204, an include parameter 206, an exclude parameter 208, and a manual parameter 210. The include parameter 206 is configured to enable limiting the selected subset to an identified category of photos while the exclude parameter 208 is configured to enable selecting the subset to exclude an identified category of photos. For example, the identified category can be defined by a particular person (e.g. Aunt Melba) with the exclude parameter 208 applied to exclude photos of that particular person (alone or with others) from the second media compilation 188.

The person parameter 200 is configured to enable sorting and selecting photos within the first media compilation 134 to identify a person or persons that will be included or excluded from the second media compilation 188. The sub-event parameter is configured to enable sorting and selecting photos within the first media compilation 134 to identify a sub-event or sub-events that will be included or excluded from the second media compilation 188. For example, in the instance in which a first media compilation 134 relates to a wedding album, one of the sub-events is a rehearsal dinner, and the sub-event parameter 202 can be used to identify photos of the rehearsal dinner and define the subset of photos used in the second media compilation 188 as those of the rehearsal dinner. Alternatively, in another embodiment, this identification of the sub-event is used in cooperation with the exclude parameter 208 to leave intact the collection of photos of the first media compilation 134 while excluding the photos of the rehearsal dinner.

In one aspect, the temporal parameter 204 is configured to enable including, excluding, or sorting photos of the first media compilation 134 according to temporal factors, such as a calendar day, time of day, day of the week, etc. The auto-generate function 182 is configured to enable the author to elect that the second media compilation 188 be generated automatically, after identifying the subset of photos to be included, via automatic application of the first editing metadata of the first media compilation 134.

The author parameter 184 is configured to enable identifying the individual authors producing the various media compilations, as the author of the second media compilation 188 may or may not be the same author that produced the first media compilation 134.

In general terms, the auxiliary composition editor 186 of derivative monitor 120 includes substantially the same features and attributes as the composition editor 132 and is configured to enable modification (via composing and editing) of the second media compilation 188. In one aspect, the auxiliary composition editor 186 includes a second editing metadata 187 produced via the actions of composing and editing the second media compilation 188. This second editing metadata 187 can be used to produce successive derivative media compilations 190 from the derived media compilation 188 (such as a second media compilation).

In some embodiments, the compilation manager 100 also includes an output monitor 200, as shown in FIG. 2. In general terms, output monitor 200 enables selection of the type of output of the first media compilation 134, the second media compilation 188, or successive derivations 190. This output is generally complementary to the selected format of the respective media compilations. In one embodiment, output monitor 200 comprises a photobook function 210, a DVD function 212, a slideshow function 214, a collage function 216, a pamphlet function 218, and a three-dimensional object function 220. However, it will be understood by those skilled in the art that other known formats may be used.

In one embodiment, the photobook function 210 causes a media compilation to be printed as a photobook with each photo being directly printed on a page of the photobook (instead of the conventional method of physically pasting photos onto a separate piece of paper) so that one piece of paper forms the photo and the page on which it appears, whereas the DVD function 212 causes the first media compilation 134 to be saved on, and displayable, via a DVD. The slideshow function 212 causes the first media compilation 134 to be saved, and displayable, via a general slideshow software program (e.g., Microsoft® PowerPoint®) or other photo slideshow program. The collage function 216 or the pamphlet function 218 causes the first media compilation to be printed as a collage or a pamphlet, respectively, while the three-dimensional object function 220 causes the first media compilation to be printed as a sheet that is constructible into, or attachable to, three-dimensional object.

In general terms, the comprehensive metadata manager 225 is configured as a database to comprehensively store and manage metadata produced via operation of compilation manager 100. In one embodiment, this comprehensive metadata is stored as part of, and associated with, corresponding media elements or media compilations at a source (e.g. source 21 of FIG. 1).

In some embodiments, the comprehensive metadata manager 225 includes a migration function 230, a public function 232, and a personal function 234. In one embodiment, the migration function 230 controls which content metadata and/or editing metadata associated with master monitor 110 or derivative monitor 120 is allowed to migrate (or alternatively, to be prevented from migrating) into the database of the comprehensive metadata manager 225. In particular, the migration function 230 of the comprehensive metadata manager 225 operates in cooperation with a migrate function 299 of a content data monitor 250 (FIG. 3) and/or with a migrate function 381 of an editing metadata monitor 300 (FIG. 4) in order to control which metadata migrates to the comprehensive metadata manager 225. In one aspect, the migration function 230 acts as a feedback loop from the media elements back to the source from which media elements are initially selected. In other words, this migrated editing metadata is stored as part of, and associated with, corresponding media elements in the database of metadata manager 225 so that this migrated metadata becomes part of the content initially selectable when producing a media compilation. Accordingly, comprehensive metadata manager 225 leverages the “human” metadata (i.e. metadata that results from decisions of authors) by making it accessible by the same author or other authors to augment their initial selection (or derivative selection) of media elements when producing a media compilation.

In one embodiment, the comprehensive metadata manager 225 comprises a public function 232 and/or a personal function 234 to control the level of access to a particular instance of metadata or group of metadata is to be made accessible. In one example, public function 232 makes a particular metadata freely accessible to the public while the private function 234 restricts some or all of a particular metadata for access to a limited set of authors via personal function 234. FIG. 3 is a block diagram of a content metadata monitor 250, according to one embodiment of the present disclosure. In general terms, content metadata monitor 250 is configured to track data associated with a photo (or other media element) at the time that the photo was captured or at a later time when an author electronically labeled the photo with identifying information.

As shown in FIG. 3, in one embodiment, content metadata monitor 250 comprises a photo module 260, a camera module 270, and a migrate function 299. In general terms, the photo module 260 is configured to track metadata obtained via electronically analyzing or observing the subject(s) of each photo. The photo module 260 comprises a facial parameter 272, a gender parameter 274, a group parameter 276, a single parameter 278, an event parameter 280, and a rating parameter 282. In general, these parameters 272-282 facilitate sorting and/or selecting various photos from one another and are not an exhaustive list of the exemplary parameters of content metadata obtainable from a photo.

In one aspect, the facial parameter 272 identifies a person, or differentiates between different people within a photo according to their facial features while the gender parameter 274 identifies the gender of a person, or differentiates between the gender of different people within a photo. The group parameter 276 identifies groups of people within photos while the single parameter 278 identifies photos with a single person in the photo. The event parameter 280 identifies photos relating to a type of event (e.g. a baseball game) according to features (e.g., balls, grass, fence, etc.) in the photo associated with that type of event. The rating parameter 282 enables a user to rate a photo according to desirability or other factors (e.g. image quality).

In general terms, the camera module 270 is configured to track metadata produced by the camera at the time a photo was taken and that is directly associated with each photo. In one embodiment, the camera module comprises a temporal parameter 290, a histogram parameter 292, a location parameter 294, a capture mode parameter 296, and a user tag parameter 298. In general, these parameters 290-298 facilitate sorting and/or selecting various photos from one another and are not an exhaustive list of the exemplary parameters of content metadata producible by a camera in association with a photo.

In one aspect, the temporal parameter 290 reveals a time or day at which a photo was taken while the histogram parameter 292 reveals a color pattern or intensity pattern within a photo. The location parameter 294 reveals a geographic location at which the photo was taken, when the image capturing device includes GPS (i.e. Global Positioning System) capability. The capture mode parameter 296 reveals a mode (e.g. Sports, Night, etc.) in which the camera was operating at the time the photo was taken while the user tag parameter 298 reveals the user of the camera that took the photo.

In some embodiments, the content metadata monitor 250 includes the migrate function 299 that controls whether content metadata associated with production of a media compilation is allowed to migrate to become part of a comprehensive metadata database stored within comprehensive metadata manager 224 (FIG. 2) or whether that particular content metadata is to be limited to the particular media compilation being produced, and therefore remains solely as part of content metadata 142. As previously noted, the migrate function 299 acts in cooperation with migration function 230 of comprehensive metadata manager 225 of FIG. 2.

FIG. 4 is a block diagram of an editing metadata monitor 300, according to one embodiment of the present disclosure. In general terms, editing metadata monitor 300 is configured to track the choices made by an author via method 10 and/or via compilation manager 100 while composing and editing a media compilation. Accordingly, it will be further understood that the various parameters, functions, monitors, and/or modules within editing metadata monitor 300 also represent some of the types of choices available via the composition editor 132 and/or auxiliary composition editor 186 of compilation manager 100 of FIG. 2. Accordingly, these respective parameters reflect both choices that have been made as well as the type of choices available to be made by an author. Finally, this tracking information also can be displayed via a history parameter 380 to view the choices, and resulting changes, made by an author.

As shown in FIG. 4, content metadata monitor 300 comprises an array 301 of parameters associated with or produced via composing and editing a media compilation. The parameters of array 301 are not exhaustive, and the particular editing metadata associated with a first media compilation or a derived media compilation may be more or less than the named parameters of array 301.

In some embodiments, as shown in FIG. 4, the array 301 includes one or more of a clustering parameter 302, a theme parameter 304, a favorite parameter 306, a sequence parameter 308, an event parameter 310, a lock parameter 312, a size module 320, and a page module 330.

The clustering parameter 302 tracks which photos or sets of photos are clustered together within a media compilation while the theme parameter 304 tracks a theme identified by the author or automatically generated via analysis of the content metadata of the photos. The favorite parameter 306 tracks certain photos over other photos. The sequence parameter 308 tracks the sequence of photos created by the author or as automatically generated based on content metadata or other tagging. The event parameter 310 operates in cooperation with the theme parameter 304 to track photos associated with an event (e.g., graduation, birthday, etc.), as chosen by the author. The lock parameter 312 enables the author to lock a portion of a first media compilation to prevent changes to that locked portion while other portions of the first media compilation are modified as part of producing the derived media compilation from the first media compilation.

The size module 320 tracks decisions regarding an absolute size of a photo, via absolute parameter 322, or regarding the relative sizes of photos in the media compilation, via relative parameter 324.

The page module 330 tracks which page or pages that a photo will be associated with, via association parameter 332, or which page or pages will display a cluster of photos, via cluster parameter 334.

In some embodiments, the array 301 also includes one or more of a color compatibility parameter 340, a position-on-page parameter 350, an elements-per-page parameter 352, an isolation parameter 354, an orientation parameter 360, a family parameter 362, an individual's parameter 364, and a gender parameter 370. The color compatibility parameter 340 tracks compatibility between different color patterns of photos as the photos are arranged together in the media compilation. The blank space parameter 342 tracks the size and placement of intentional blank space regions on a page or blank space pages within a compilation. The position-on-page parameter 350 tracks determining the absolute or relative position of photos on a page or pages. The elements-per-page parameter 352 tracks determining a quantity of photos (and/or other media elements) that is allowed on a given page or pages. The isolation parameter 354 is configured to track isolation of a particular photo relative to other photos to better highlight that particular photo. The orientation parameter 360 tracks the orientation (e.g., an angle) of the photo on the page. The family parameter 362 tracks identifying a family within one or more photos while single parameter 364 tracks identifying a single person from among a group of people. The gender parameter 370 tracks the intentional inclusion or exclusion of photos based on a gender of the persons in the photo. The history parameter 380 tracks a history of editing decisions made by a particular author and/or on a particular media compilation. Such information can help later authors (or the original author) determine the steps taken to achieve a particular media compilation.

In some embodiments, the migrate function 381 of editing metadata monitor 300 controls whether editing metadata associated with production of a media compilation is allowed to migrate to become part of a comprehensive metadata database stored within comprehensive metadata manager 225 (FIG. 2) or whether that particular editing metadata is to be limited to the particular media compilation being produced, and therefore remains solely as part of first editing metadata 160, part of second editing metadata 187, etc. Accordingly, the migrate function 381 acts in cooperation with the migration function 230 of comprehensive metadata manager 225 of FIG. 2.

In some embodiments, the various modules, functions, parameters, managers, and/or monitors described in association with FIGS. 1-7 are rearrangeable into different combinations, and therefore are not strictly to the combinations and groupings shown in FIGS. 1-7.

FIG. 5 schematically illustrates one non-limiting example of a method of producing a derivative media compilation 404 from a first media compilation 402, according to one embodiment of the present disclosure. As shown in FIG. 5, the first media compilation 402 includes an arrangement of photos (and other media elements, such as graphics, text, or non-photo images) created by an author via composing and editing the arrangement. It will be understood that this first media compilation 402 is merely an example, and that other first media compilations can take a variety of forms. As shown in FIG. 5, first media compilation 402 comprises a photo book includes a series of chapters 410, 412, 414, 416, and 418 that groups photos into different clusters with each chapter corresponding to a cluster of photos. In this example, the first media compilation 402 relates to a seasonal sports activity, such as baseball. Accordingly, each of the five chapters relate to this seasonal sports activity and photos were selected by the author from a source to define a first content or collection of photos related to that activity.

As shown in FIG. 5, the first chapter 410 includes photos of all members of the baseball team at practices, with each page having several photos. The second chapter 412 includes photos of all or most team members in action shots during a first game while the third chapter 414 includes photos of all or most team members in action shots during one or more subsequent games. It will be understood that the order of chapters can be rearranged and that chapters can be added or removed. The fourth chapter 416 includes one photo per page and includes photos, such as a team picture, photos of each individual player, photos of each coach, etc. The fifth chapter 418 includes photos of the end-of-year party including the whole team.

In order to make a derivative or second media compilation, an author selects a subset of the photos of the first media compilation. In one example, the author could choose to focus on one individual member of the team with the goal of producing a season journal of that individual member or player. In this example, the author chooses to derive a season journal of Andy.

Accordingly, as shown at 440, in this method the author defines the subset of photos (e.g., Andy's photos) from the collection of photos of the first media compilation and the editing metadata (that was produced during creation of the first media compilation 402) is applied automatically to produce the second media compilation 404.

As shown in FIG. 5, in the second media compilation the first chapter 430 includes all photos of Andy at practices while placing several photos per page. The second chapter 432 includes photos of Andy (with or without other teammates) in action shots during a first game while the third chapter 434 includes photos of at least Andy in action shots during one or more subsequent games. The fourth chapter 436 includes photos such as a team picture, photos of Andy, photos of each coach, etc. with one photo per page of the journal. The fifth chapter 438 includes photos of the end-of-year party including photos of at least Andy, whether or not other teammates are in those same photos.

FIG. 6 schematically illustrates one non-limiting example of a method of producing a derivative media compilation 504 from a first media compilation 502, according to one embodiment of the present disclosure. As shown in FIG. 6, the first media compilation 502 includes an arrangement of media elements, such as graphics 542, text 550A, 552A, non-photo images, and photos P1, P2, P3, etc. as created by an author via composing and editing the arrangement. It will be understood that this first media compilation 502 is merely an example, and that other first media compilations can take a variety of forms. In the particular example shown, the first media compilation takes the form of a tri-fold pamphlet.

As shown in FIG. 6, first media compilation 502 includes a first page 510, a second page 512, and a third page 514 with each page having a unique aggregation of media elements. In this example, the first media compilation 502 relates to a brochure for an outdoor recreation opportunity as noted via title 540 (e.g. Outdoor Voyages). Accordingly, each of the three pages of the pamphlet 520 relate to this outdoor opportunity and the media elements (graphics 542, photos P1, P2, etc.) were selected by the author from a source to define a first content or collection of media elements related to the outdoor opportunity.

As shown in FIG. 6, in addition to title 540, page 510 of first media compilation 502 further comprises location component 544A with photo P1, and activity component 546A with photos P2 and P3. Graphic elements 542 are placed throughout the entire pamphlet. Page 512 of first media compilation 502 comprises general description component 550A, specific description component 552A, activity component 547A with photo P4, and location component 545A with photo P5. Page 514 of first media compilation 502 comprises lodging component 560A with photo P6, fees component 562A, and contact info component 564.

In a manner substantially the same as previously described for the embodiment of FIG. 5, an author composes and edits the three pages 510-514 of the pamphlet after the content has been selected from a source. In one aspect, in addition to the selected photos P1-P6, the selected content includes the text or images associated with: (1) the location components 544A, 545A; (2) the activity components 546A, 547A; (3) the general description component 550A; (4) the specific description component 552A; (5) the lodging component 560A; (6) the fees component 562A; and (7) the contact info component 564.

In general terms, the location components 544A, 545A provide descriptive information about a locality, state, region, or country in which the outdoor activity will take place. The activity components 546A, 547A provide descriptive information about the specific aspects of the general activity, such as biking, hiking, naturalist seminars, boating, etc. For each respective location component 544A, 545A, an appropriate photo P1, P5 is included in context with that descriptive information. Similarly, for each respective activity component 546A, 547A, an appropriate photo P2, P3, P4 of the specific activity (e.g. boating) is included in context with that descriptive information to accentuate the descriptive information.

On page 512, the general description component 550A provides descriptive information that is generally applicable to any activity offered by the sponsoring entity while the specific description component 552A provides descriptive information unique to the specific activity offered.

On page 514, the lodging component 560A provides descriptive information about the lodging accommodations (e.g. camping, cabin, etc.) while the fees component 562A provides descriptive information about the fees of the activity. The contact info component 564 provides descriptive information that is generally applicable to any activity offered.

In general terms, the first media compilation 502 is a custom document created by an author and does not correspond to a document produced via conventional variable data printing. Accordingly, as the author composes and edits the first media compilation 502, editing metadata 516 is produced which reflects each choice the author made in composing and editing the first media compilation.

In order to create a second media compilation that leverages the effort in creating the first media compilation, the author (same or different author) begins with the first media compilation as a base. In particular, the author first defines a subset 518 of the content of the first media compilation.

In some embodiments, this subset 518 of content of first media compilation is supplemented by additional content from source 520.

In one example, first media compilation 502 is a pamphlet detailing an outdoor activity to a first location, for a first age group, and involving a first activity, such as camping and bicycling. The second media compilation is a pamphlet detailing an outdoor activity to a second, different location, for a second age group, and involving a second, different activity, such as outdoor naturalist seminars. Because the editing metadata associated with the first media compilation was tracked and stored, an author can quickly create the second media compilation.

As shown in FIG. 6, the second media compilation 504 includes generally the same corresponding components as first media compilation 502, except for updating the respective location components 544B, 545B with replacement text and photos P7, P11 and updating the respective activity components 546B, 5476 with replacement text and photos P8, P9, P10. Similarly, the specific descriptive text component 5526 and fees component 562B is updated with replacement text while the lodging component 560B is updated with replacement text and photo P12.

In general terms, while the content (e.g. text and photos) are updated in second media compilation, the editing metadata is applied to ensure that the custom layout, themes, and format expressed in the first media compilation are generally preserved when appearing in the second media compilation.

In a likewise manner, this process can be repeated in a recursive manner to produce successive media compilations with each subsequent media compilation being a derivative of the immediately preceding (or other preceding) compilation.

FIG. 7 is a block diagram that schematically illustrates a computer system 600 configured to produce derivative media compilations from a master or first media compilation, according to one embodiment of the present disclosure. As shown in FIG. 7, computer system 600 comprises a first computer 602, a content service provider 604, a compilation service provider 606, an output provider 608, and a network communication link 610. In one aspect, the network communication link 610, as used herein, includes an Internet communication link, an intranet communication link, or similar high-speed communication link, each of which enable wired and/or wireless communication.

The first computer 602 comprises a controller 630, a user interface 632, a memory 634, and a compilation manager 636. Among other things, the memory 634 is configured to store media elements 530, such as photos 650, graphics 662, non-photo images 664, and text 667. In one embodiment, the compilation manager 636 comprises substantially the same features and attributes as the compilation manager 100 as described and illustrated in association with FIG. 2. The compilation manager 636 utilizes the media elements 650 stored in memory 634 to produce one or more media compilations, in a manner substantially the same as described in association with FIGS. 1-6.

The controller 630 comprises one or more processing units and associated memories configured to generate control signals directing the operation of first computer 602 and its components. For purposes of this application, the term “processing unit” shall mean a presently developed or future developed processing unit that executes sequences of instructions contained in a memory, such as memory 634 or other memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 602 may be embodied as part of one or more application-specific integrated circuits (ASICs). Unless otherwise specifically noted, the controller is not limited to any specific combination of hardware circuitry and software, nor limited to any particular source for the instructions executed by the processing unit.

In one aspect, the user interface 632 comprises a graphical user interface configured to display, and enable operation of, the various parameters, components, and functions of the respective parameters, modules, monitors, managers, and/or functions of first computer 602 including compilation manager 636 (like compilation manager 100 of FIG. 2). Accordingly, via user interface 632, manager 636 of FIG. 7 or manager 100 of FIG. 2 represents the display of the respective parameters, components, functions, monitors, managers, and/or modules as well as representing the ability to activate or operate those respective parameters, components, functions, monitors, managers, and/or modules.

The content service provider 604 provides access to third party content by the first computer 602, via network communication link 610, so that other media elements 680 may be incorporated into the media compilation being produced by the author at the first computer 602.

In some embodiments, system 600 includes a compilation service provider 606 accessible by the first computer 602 via network communication link 610. The compilation service provider 606 provides a web site or portal at which an author can produce a media compilation and/or derive a second media compilation from a first media compilation. Accordingly, the compilation service provider 606 includes a compilation manager 685 having at least substantially the same features and attributes as compilation manager 100 (FIG. 2) or compilation manager 636. The compilation service provider 606 is utilized when an author does not have direct access to a computer with a compilation manager or when the compilation service provider 606 provides extra features not available in the compilation manager 636 on first computer 602.

In general terms, the output provider 608 comprises one or more devices suitable for printing the one or more media compilations into a paper or for storing/writing the media compilation into a digital storage format. In one embodiment, the output provider 608 comprises at least a printer 690 or a DVD writer 692, with it being understood that many other output devices can be used. The output provider 608 can be accessed via network communication link 610 or directly from first computer 602.

Embodiments of the present invention enable efficient production of a second media compilation as a derivative of a first media compilation by leveraging the editing metadata generated during creation of the first media compilation. In this way, an author can readily create the second media compilation of a subset of the content of the first media compilation by taking advantage of the previous composition and editing work expressed in the first media compilation. In other words, an author need not start over in their composition and editing work when assembling a second media compilation that is related to the first media compilation.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A media compilation manager comprising:
a master monitor comprising:
a content selector configured to enable selection of a first set of media elements; and
a composition editor configured to enable composing and editing a first media compilation that comprises at least a portion of the first set and configured to track a first editing metadata produced as a byproduct of the composing and editing of the first media compilation; and
a derivative monitor comprising:
a subset selector configured to enable selection of a first subset the media elements of the first media compilation; and
a compilation generator configured to automatically produce a second media compilation via automatically applying the first editing metadata to the first subset of media elements.

2. The manager of claim 1 wherein the media elements comprise at least one of an image, graphics, or text, wherein the image comprises at least one of a photo or other type of image.

3. The manager of claim 1, and further comprising at least one of:
a computer system comprising a first computer that is configured to store the media compilation manager; or
a compilation service provider configured to be accessible by a first computer via a network communication link and configured to store the media compilation manager.

4. The manager of claim 1, wherein the subset selector is configured to enable selection of a second subset of the media elements of the second media compilation, and wherein the compilation generator is configured to automatically produce a third media compilation via automatically applying the first editing metadata to the second subset of media elements.

5. The manager of claim 4 wherein the derivative monitor comprises a second composition editor, or enables access to the composition editor of the master monitor, to enable composing and editing the second media compilation that comprises the first subset and to track a second editing metadata produced as a byproduct of the composing and editing of the second media compilation, wherein the third media compilation is automatically produced via application of the second editing metadata instead of the first editing metadata.

6. The manager of claim 1, wherein the subset selector comprises at least one of:
an exclusion function configured to define the first subset via excluding media elements of the first content that are associated with a first category; and
an inclusion function configured to define the subset via limiting the subset to media elements of the first content that are associated with a second category.

7. The manager of claim 6, wherein the first category comprises one or more persons and the second category comprises one or more persons, wherein the persons in the first category are different than the persons in the second category.

8. The manager of claim 1 wherein first editing metadata comprises:
at least one of:
a clustering parameter;
a theme parameter;
a favored parameter;
a lock parameter;
an absolute size parameter;
a relative size parameter;
a page association parameter;
a page clustering parameter;
a color compatibility parameter;
a position-on-page parameter;
an elements-per-page parameter;
an element sequence parameter;
an isolation parameter;
an orientation parameter;
an event-type grouping criteria;
a family grouping criteria;
an individual identification criteria;
a gender identification criteria; or
an isolation parameter.

9. The manager of claim 1 wherein the content selector is configured to enable selection of the first set of media elements according to a first content metadata, the first content metadata comprising at least one of:
a facial recognition parameter;
a gender identification parameter;
an event-type grouping parameter;
a grouping parameter;
an individual identification parameter; or
a camera-generated parameters comprising at least one of:
a temporal parameter;
a histogram parameter;
a GPS parameter; or
at least one capture mode parameter.

10. The manager of claim 1, comprising a metadata manager comprising at least one of:
a migration function configured to direct which editing metadata will be stored as part of, and associated with, corresponding media elements in a source from which the first media elements are selected;
a public function configured to select which editing metadata will be freely accessible to the public; or
a private function configured to select which editing metadata will be accessible to limited set of authors.

11. A computer-readable medium having computer-executable instructions for performing a method of producing media compilations, the method comprising:
authoring a first media compilation comprising:
selecting a first content of media elements from a content source; and
composing and editing at least a portion of the first content to form the first media compilation while tracking first editing metadata produced via the composing and editing; and
authoring, with the first media compilation as a source, a second media compilation via:
identifying a first subset of the portion of the first content; and
automatically generating the second media compilation via automatically applying the first editing metadata to the first subset.

12. The computer-readable medium of claim 11, wherein the first content of media elements comprises a theme-based format of photographs regarding a first group of people and the first subset is limited to one or more individuals within the first group with the one or more individuals comprising a quantity less than a total number of individuals within the first group.

13. The computer-readable medium of claim 11, wherein composing and editing comprises:
automatically generating the first media compilation from the selected first content according to the first content metadata and a preselected theme-based format; and
further composing and editing the first media compilation.

14. A media compilation service provider comprising:
a master monitor comprising:
a content selector configured to enable selection of a first set of media elements; and
a composition editor configured to enable composing and editing a first media compilation that comprises at least a portion of the first set and configured to track a first editing metadata produced as a byproduct of the composing and editing of the first media compilation; and
a derivative monitor comprising:
a subset selector configured to enable selection of a first subset the media elements of the first media compilation; and
a compilation generator configured to automatically produce a second media compilation via automatically applying the first editing metadata to the first subset of media elements,
wherein the media compilation service provider is accessible to a first computer via a network communication link.

15. The media compilation service provider of claim 14 wherein the subset selector is configured to enable selection of a second subset of the media elements of the second media compilation, and wherein the compilation generator is configured to automatically produce a third media compilation via automatically applying the first editing metadata to the second subset of media elements.
